(19) United States
(12) Patent Application Publication
(10) Pub. No.: US 2023/0402895 A1
(43) Pub. Date: Dec. 14, 2023

(54) INSULATION SYSTEM FOR A STATOR OF AN ELECTRIC MOTOR

(71) Applicant: Hanon Systems, Daejeon (KR)

(72) Inventors: David Walisko, Hürth (DE); Frank Mau, Aachen (DE); Marco Hombitzer, Alsdorf (DE)

(21) Appl. No.: 18/334,557

(22) Filed: Jun. 14, 2023

(30) Foreign Application Priority Data
Jun. 14, 2022 (DE) 10 2022 114 904.8
Apr. 27, 2023 (DE) 10 2023 110 854.9

(51) Int. Cl. H02K 3/52; F25B 31/02

(52) U.S. Cl. CPC H02K 3/522; F25B 31/026; H02K 2203/12

(57) ABSTRACT

An insulation system for a stator of an electric motor, in particular for an electric motor of an electrical compressor, wherein the stator has multiple coil carriers which point radially inwards from a stator inner side and have inner flanges spaced apart on the head side, said inner flanges radially delimiting coils wound onto the coil carriers with electrical conductors, wherein the insulation system comprises insulator elements which are each held at their foot end by holding grooves formed on the stator inner side in the axial direction between axial end sides of the stator and are positioned pointing radially inwards between adjacent coils with their head ends between opposing flanks of adjacent inner flanges, wherein an electrically insulating substance is introduced in contact regions between the insulator elements and the holding grooves and/or between the insulator elements and the inner flanges of the coil carriers.

### CROSS REFERENCE TO RELATED APPLICATION

The present application claims the benefit of and priority to German Pat. Appl. Nos. 10 2022 114 904.8, filed Jun. 14, 2022, and 10 2023 110 854.9, filed Apr. 27, 2023, the entire contents of each of which are incorporated herein by reference for all purposes.

### FIELD OF THE INVENTION

The invention relates to an electrical insulation system for a stator of an electric motor, in particular for an electric motor of an electric compressor or air-conditioning compressor of a hybrid or electric vehicle. The electric motor is used to compress a fluid in vapour form, specifically a refrigerant.

### BACKGROUND OF THE INVENTION

Electric motors of electrically operated compressors are usually designed with an annular stator core and a rotor, the rotor being arranged inside the stator core, oriented coaxially on a common axis of symmetry or axis of rotation of the rotor. The stator core comprises on its inner side multiple radially inwardly pointing carrier teeth, on which electrical conductors are arranged to form a coil. At their radially inwardly directed head ends, the carrier teeth, which are also known to a person skilled in the art as stator teeth, T-segments, coil carriers or stator poles, can have a so-called inner flange, which radially inwardly delimits the arrangement or the winding of the stator coil. The stator coils are formed for example by winding an electrical conductor onto the carrier teeth such that a free space remains in the axial direction between adjacent stator coils produced. This free space is also referred to by a person skilled in the art as a groove or stator groove, and the distances between adjacent inner flanges are referred to as stator groove openings. As is known, the carrier teeth and the electrical conductors are provided with a plastic coating or plastic encapsulation for electrical insulation. Electrical insulators are also provided in the interstice between the stator coils and between the connection lines of the electrical conductor wires and the electrically conductive stator core, in particular in the region of the inner flange of the carrier teeth.

The desire for ever more compact designs of electric motors is associated with many challenges, in particular in terms of the distances between the components of the electric motor. In order to avoid short circuits resulting from excessively small creepage paths and air gaps, sufficiently large insulation distances must be maintained between the adjacent stator coils. For electrically operated compressors, which are operated for example in the high-voltage range of up to 1000 V, for example, particularly high demands must be met in terms of the insulation distances. High voltages thus require greater creepage paths and air gaps. Within a modern electric motor for very high voltages of approximately 400 V, in which the shortest air gap between two stator coils may usually be approximately 4 mm and the shortest creepage path may usually be approximately 5 mm, the electrical insulation system for use at ultra-high voltages of up to 1000 V is an even greater challenge.

An insulation arrangement for an electric motor of an electrical compressor is known from DE 10 2019 112 534. The insulation arrangement is provided for an electric motor having a stator core of the type described in the introduction. According to this design of stator core, electrical conducting wires are wound to form coils on the coil carriers, which extend radially inwards from the inner circumference of the stator ring with their inner flange formed on the head end, wherein an interstice, referred to by a person skilled in the art as a stator groove, exists between adjacent coils. In each of these interstices of the coils arranged radially on the inner circumference of the stator, there is arranged a coil separator in the form of a planar element, which extends inwards from the inner circumference of the stator in the radial direction and between the axial end sides of the stator in the axial direction. A particular feature of these coil separators consists in that they have an inwardly directed Y shape in cross-section perpendicular to the longitudinal direction, wherein a fork end of the Y shape in each case delimits the interstice between adjacent coils on an axial long side of the opposing inner flanges of the coil carriers. The coil separators are held in position inside the stator grooves in a pressed-in manner by elastic deformation. The axial long sides at the foot end of the Y shape then press against the inner face of the stator ring, and the head ends each press against the axial long sides of the opposing inner flanges of the coil carriers of the stator core.

The production and installation of the known coil separators is comparatively complex owing to the cross-sectional Y shape. It has also been found that simply pressing the coil separators against the components of the stator core is not sufficient to eliminate a possible current path for the leakage current flow. The risk of a gap between the aligned and adjacent components of the stator arrangement and accordingly the risk of creepage paths and undesirable current flows thus remain.

The object of the invention is therefore that of proposing an insulation system for a stator of an electric motor, in particular an electric motor of an electrical refrigerant compressor, with which the known disadvantages can be reduced or avoided.

### SUMMARY OF THE INVENTION

The object is achieved by an insulation system having the features shown and disclosed herein.

An insulation system for a stator of an electric motor, in particular for an electric motor of an electrical compressor or air-conditioning compressor of a hybrid or electric vehicle, is proposed. The insulation system is provided for a stator which has multiple coil carriers which point radially inwards from a stator inner side and have inner flanges spaced apart on the head side, said inner flanges radially delimiting coils arranged on the coil carriers with electrical conductors. The coil carriers with the coils arranged thereon are thus arranged adjacently such that an interstice is formed between the coils and the inner flanges of adjacent coil carriers. This interstice, which is also referred to by a person skilled in the art as a stator groove, points radially inwards from the stator inner side. Between opposing flanks of adjacent inner flanges of the coil carriers there is also a gap, which is referred to by a person skilled in the art as a stator groove opening. The insulation system according to the invention comprises an arrangement of insulator elements. The insulator elements are each held at their foot end by holding grooves formed on the stator inner side in the axial direction between axial end sides of the stator and are positioned pointing radially inwards between adjacent coils with their head ends between opposing flanks of adjacent inner flanges.

The insulator elements are thus situated in a radial orientation between adjacent coils, wherein the head-side ends of the insulator elements, positioned at least with their opposing face sides between opposing flanks of adjacent inner flanges or clamped by same, close the stator groove openings. Advantageously, the head ends of the insulator elements are dimensioned such that they completely close the interstice between opposing flanks of adjacent inner flanges, so that the flank faces bear fully against the insulator elements and no air-filled free space remains between the opposing flanks.

The holding grooves which are formed on the stator inner side and in which the foot ends of the insulator elements are held are oriented as axial longitudinal grooves between the axial end sides of the stator and preferably arranged between two adjacent coil carriers such that the holding grooves and the stator groove openings can lie on a common radial. The holding grooves prove useful as guides during the arrangement of the insulator elements. Preferably, the foot ends of the insulator elements and the holding grooves can have a form-fitting geometry so that the insulator elements positioned in the holding grooves form a form fit at their foot ends. There are no restrictions in terms of the shape of the form-fitting geometry here. The axial length of the insulator elements corresponds at least to the distance between the axial end sides of the stator so that adjacent coils are spatially separated from one another both axially and radially. Advantageously, the insulator elements can protrude beyond the axial end sides of the stator in order to enlarge the air gap between adjacent coils. To this end, the length of the insulator elements in an axial orientation can be greater than the distance between the axial end sides of the stator.

According to the invention, an electrically insulating substance is introduced in the contact regions between the insulator elements and the holding grooves and/or between the insulator elements and the inner flanges of the coil carriers, in particular the opposing flanks of adjacent inner flanges. The electrically insulating substance can be in the form of a curable composition. In the introduced and cured state, the electrically insulating substance forms an adhesive join or an adhesive bonding point. The electrically insulating substance should have a certain elasticity and vibration resistance.

Within the meaning of the invention, contact regions mean the regions at which the insulator elements touch the opposing flanks of adjacent inner flanges and the holding grooves, preferably areally; this includes in particular edges of these touching positions and inner free spaces between touching positions. When introduced between the insulator elements and the holding grooves and/or between the insulator elements and the inner flanges of the coil carriers, the electrically insulating substance fills interstices which cannot be prevented by simple contact or pressure in the contact regions between the insulator elements and the holding grooves and/or between the insulator elements and the inner flanges of the coil carriers alone. Because the interstices within contact regions are filled with the electrically insulating substance, propagation paths for potential air paths and creepage paths are prevented or lengthened.

The insulator elements are electrical insulators and can be made from suitable materials.

The solution according to the invention has two essential advantages over the prior art. Firstly, the distance along the contact region at the foot ends of the insulator elements is lengthened by accommodation in the holding grooves, as a result of which the risk of creepage current breakdowns is reduced. The deeper the holding grooves in the stator inner side, the greater the distance along the contact region. Secondly, the electrical insulation is increased by introducing the electrically insulating substance, because interstices remaining in the contact regions are filled by this substance. A further advantage consists in that fewer components overall are needed to form the electrical insulation, and the insulator elements are less complex to manufacture.

According to an advantageous embodiment of the insulation system according to the invention, the insulator elements can have protrusions formed in the head region on opposing face sides. These elements protruding on both sides of the head region form supporting ridges in the axial direction, that is, in the axial direction in relation to the axis of symmetry of the stator, said supporting ridges each having at least one supporting face for opposing flanks of adjacent inner flanges of the coil carriers. These protrusions can be formed by cut-outs at the head end of the insulator elements. The head region widened by the protrusions gives the insulator elements improved stability. Advantageously, the insulator elements are dimensioned such that, in the installed state, they are each oriented with their supporting ridges radially inwards against flank undersides of adjacent inner flanges. Furthermore, it can be provided for the supporting ridges each to press radially inwards against flank undersides of adjacent inner flanges. This can be ensured by making the insulator elements larger than a distance between a groove bottom of the holding grooves and the flank undersides of adjacent inner flanges. It is self-evident that the insulator elements can have a certain elasticity.

A resin or an adhesive can be used as the electrically insulating substance. For example, a two-component adhesive can be used as the electrically insulating substance. Preferably, this electrically insulating substance is liquid to paste-like before introduction into the contact regions. The introduction of the electrically insulating substance into interstices of the contact regions between the insulator elements and the holding grooves and/or between the insulator elements and the inner flanges of the coil carriers can take place using a vacuum pressure process after the insulator elements have been brought into position. Furthermore, it can be provided for the electrically insulating substance to be applied to the contact points before positioning, so that the electrically insulating substance is already at the desired position when the insulator elements are positioned.

In order to achieve the largest possible contact region of the opposing flanks of adjacent inner flanges, the insulator elements can protrude with their head ends pointing radially inwards beyond the inner flanges of the coil carriers. The contact region between the inner flanges and the insulator elements thus advantageously increases, starting from the supporting ridges on which the flank undersides of the inner flanges lie, along the flank faces which bear against the opposite face sides of the insulator elements. A further enlargement of the contact regions can be achieved by enlarging the supporting face of the supporting ridges.

According to a further advantageous embodiment of the insulation system according to the invention, it can be provided for the insulator elements to protrude in the axial direction beyond the coils of the coil carriers. This ensures that a longer air insulation distance is formed in the axial direction between the electrical conductor of the coil and the stator end sides or end faces and between adjacent coils.

The insulator elements can preferably be substantially planar, but other shapes or surface profiles are conceivable, to allow better utilisation of the installation space. The term planar within the meaning of the invention means a substantially flat body, the length and width of which is substantially greater than its thickness.

To simplify the installation of the planar insulator elements, it is provided for the planar insulator elements to be insertable into the stator at least one axial stator end side. Accordingly, the holding grooves can have an axial groove opening at the axial end side for insertion of the planar insulator elements.

The invention also comprises a stator arrangement having the insulation system according to the invention. This stator arrangement is provided for an electric motor, in particular for an electric motor of an electrical compressor. The stator arrangement has a stator with multiple coil carriers which point radially inwards from a stator inner side and have inner flanges spaced apart on the head side, said inner flanges radially delimiting coils arranged on the coil carriers with electrical conductors. According to the invention, holding grooves for holding insulator elements are formed on the stator inner side in the axial direction between axial end sides of the stator.

These holding grooves are preferably arranged in an axial orientation between the coil carriers such that the holding grooves and the stator groove openings lie on a common line between adjacent inner flanges of the stator carriers. The stator arrangement also comprises insulator elements, which are arranged with their foot ends held in the holding grooves and point radially inwards between adjacent coils, thus closing the gap between opposing flanks of adjacent inner flanges—this means the stator groove opening. According to the invention, an electrically insulating substance is introduced in contact regions between the insulator elements and the holding grooves and/or in contact regions between the insulator elements and the inner flanges of the coil carriers. Preferably, the insulator elements are fixed to the contact regions by being glued into the stator.

Furthermore, the invention comprises a method for installing the insulation system according to the invention into a stator of an electric motor, in particular of an electric motor of an electrical compressor. The procedure is such that the insulator elements are each positioned with their foot end in holding grooves formed on the stator inner side in the axial direction between axial end sides of the stator, and pointing radially inwards between adjacent coils, and in the process are clamped with their head ends between opposing flanks of adjacent inner flanges, so that the supporting ridges of the insulator elements press radially inwards against flank undersides of adjacent inner flanges. The insulator elements can be inserted into the holding grooves from an axial end side for positioning in the axial direction. Alternatively, the insulator elements can be inserted radially into the holding grooves, with the head ends of the insulator elements locking in between opposing flanks of the adjacent inner flanges.

An electrically insulating substance is introduced between the insulator elements and the holding grooves and/or between the insulator elements and the inner flanges of the coil carriers. The electrically insulating substance can be applied to the insulator elements and/or to the contact faces of the holding grooves before positioning, so that the electrically insulating substance is already in the relevant contact regions before the positioning of the insulator elements.

Alternatively, the electrically insulating substance can be introduced after the positioning of the insulator elements. It can be provided for a vacuum pressure process to be used to introduce the electrically insulating substance.

A physically or chemically curable substance can be used as the electrically insulating substance. In this case, a further step can be provided, in which the electrically insulating substance is actively cured by means of a physical or chemical influencing variable. For example, an electrically insulating substance can be used in which curing can be activated by the influence of an additional chemical component and/or the input of heat, for example by means of microwave radiation. For example, an electrically insulating substance can be used in which curing is activatable by the influence of an additional chemical component and/or the input of heat, for example by means of microwave radiation. The selected electrically insulating substance should be elastic and vibration-stable in the cured state.

### BRIEF DESCRIPTION OF THE DRAWINGS

Further details, features and advantages of embodiments of the invention can be found in the description of exemplary embodiments below with reference to the associated drawings. In the drawings:

FIG. 1A: shows a perspective view of the insulation system according to the invention in a stator from a first end,

FIG. 1B: shows a perspective view the insulation system according to the invention in the stator from a second end,

FIG. 2: shows a schematic illustration of an enlarged detail of planar insulator elements of the insulation system according to the invention in a stator,

FIG. 3: shows a schematic sectional illustration of a stator with a single planar insulator element of the insulation system according to the invention, and

FIG. 4: shows a schematic detail illustration of a planar insulator element in an axial view from above,

FIG. 5A: shows a perspective view of the insulation system according to the invention in a stator,

FIG. 5B: shows an enlarged fragmentary perspective view of the insulation system according to the invention in the stator shown in FIG. 5A,

FIG. 6A: shows a top plan view of the insulation system according to the invention in a stator, and

FIG. 6B: shows an enlarged fragmentary top plan view of a region of the stator shown in FIG. 6A.

### DETAILED DESCRIPTION OF THE INVENTION

Recurring features are labelled with the same reference signs in the figures.

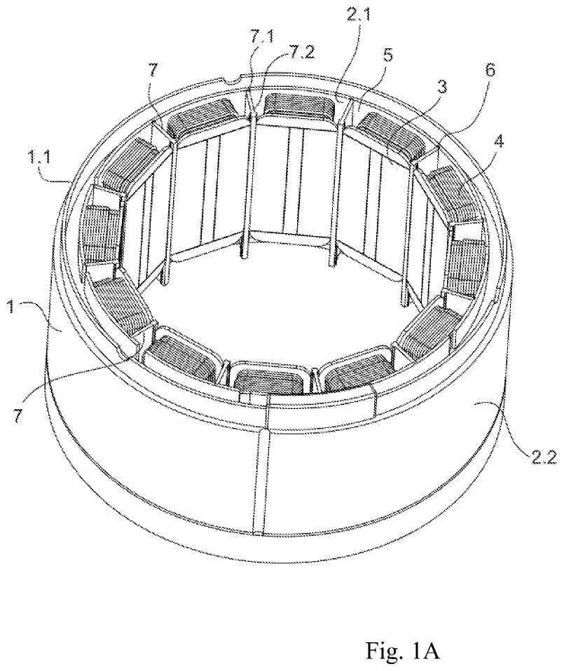

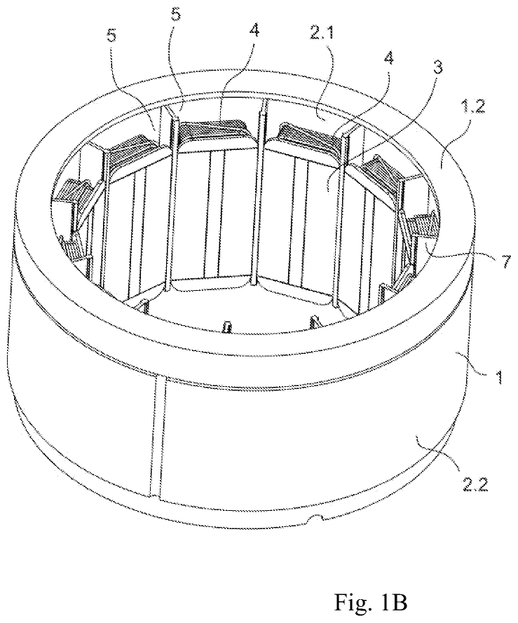

FIGS. 1A and 1B show two different views of the insulation system according to the invention of a stator 1 for an electric motor of a refrigerant compressor. In FIG. 1A, the stator 1 is shown with a perspective view from above onto a first end side 1.1, this side forming the plug side. In FIG. 1B, the stator 1 is shown with a perspective view from above onto a second end side 1.2, this end side 1.2 forming the scroll side. The stator 1 has the shape of a circular ring-shaped cylinder, having an inner side 2.1 and an outer side 2.2. On the stator inner side 2.1 there are twelve radially inwardly pointing coil carriers with inner flanges 3 which are spaced apart on the head side and radially delimit coils 4 wound onto the coil carriers with electrical conductors. The coil carriers with the coils 4 wound thereon and their inner flanges 3 are arranged adjacently such that an interstice 5 is formed between the coils 4 and the inner flanges 3 of adjacent coil carriers. This interstice 5, which is referred to as a stator groove, extends from the stator inner side 2.1, i.e., from the inner circumference of the stator 1, radially inwards and has a stator groove opening between opposing flanks of adjacent inner flanges 3. Between the coil carriers, holding grooves 6 in the form of longitudinal grooves are formed on the stator inner side 2.1 in the axial direction between the axial end sides 1.1 and 1.2 of the stator 1. The holding grooves 6 and the stator groove openings are arranged on a common radial. The insulation system comprises twelve planar insulator elements 7, which are each held form-fittingly at their foot end 7.1 by one of the holding grooves 6. The planar insulator elements 7 are arranged pointing radially inwards in the interstice 5 between adjacent coils 4 with their head end 7.2 clamped between opposing flanks of adjacent inner flanges 3. In the radial direction, the head ends 7.2 of the planar insulator elements 7 protrude beyond the inner flanges 3. In the axial direction, the planar insulator elements 7 are dimensioned such that they protrude beyond the coils 4 without protruding axially beyond the end planes of the axial end sides 1.1 and 1.2.

The planar insulator elements 7 are glued into the stator, in which an electrically insulating, cured substance is introduced in the contact regions between the planar insulator elements 7 and the holding grooves 6 and in contact regions between the planar insulator elements 7 and the inner flanges 3 of the coil carriers. This substance forms an elastic adhesive connection in the relevant contact regions.

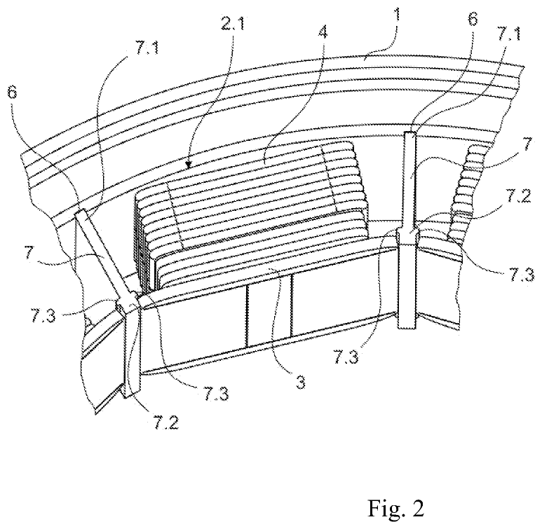

FIG. 2 shows a schematic illustration of an enlarged detail of planar insulator elements 7 of the insulation system according to the invention in a stator 1. The extract shows coil carriers pointing radially inwards from the stator inner side 2.1 with coils 4 wound thereon and radially delimited by inner flanges 3 of the coil carriers. Between the adjacently arranged coils 4, interstices 5 are formed, in which the planar insulator elements 7 are arranged such that the interstices are divided into two halves. The foot ends 7.1 of the planar insulator elements 7 are held in the holding grooves 6 formed axially on the stator inner side 2.1. On the head region, the planar insulator elements 7 have protrusions 7.3 formed on opposing face sides. These elements 7.3 protruding on both sides of the face sides form supporting ridges in the axial direction, that is, in the axial direction in relation to the axis of symmetry of the stator 1, said supporting ridges each having a supporting face for opposing flanks of adjacent inner flanges 3 of the coil carriers. The protrusions 7.3 are formed by recesses at the head end 7.2 of the planar insulator elements 7. With their protrusions 7.3, which form supporting ridges, the planar insulator elements each press radially inwards against flank undersides of adjacent inner flanges 3. In the radial orientation, the planar insulator elements 7 are oversized to ensure a press fit. The planar insulator elements 7 are thus also clamped with their head end 7.2 between opposing flanks of adjacent inner flanges 3. The contact region between the planar insulator elements 7 and the adjacent inner flanges 3 extends from the supporting faces of the supporting ridges formed by the protrusions 7.3 over the opposing face sides which are in contact with the opposing flanks of the adjacent inner flanges 3.

At their foot ends 7.1, the planar insulator elements 7 have a contact region with a holding groove 6 formed on the stator inner side 2.1. An electrically insulating substance is introduced in the contact regions between the planar insulator elements 7 and the holding grooves 6 and in contact regions between the planar insulator elements 7 and the inner flanges 3 of the coil carriers, said electrically insulating substance fixing the planar insulator elements 7 in the contact regions when in the cured state.

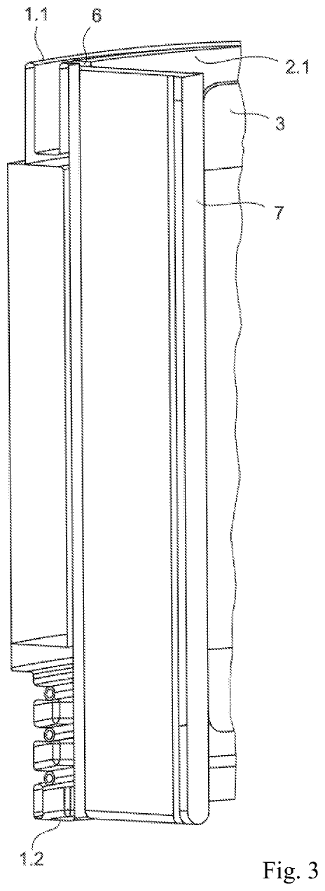

FIG. 3 shows a schematic sectional illustration of a stator 1 having a single planar insulator element 7, which is inserted with the foot end 7.1 in the holding groove 6. The axial long side of the planar insulator element 7 extends from the first end side 1.1 along the stator inner side 2.1 to the second end side 1.2. The planar insulator element 7 has a rectangular shape in the axial longitudinal orientation shown.

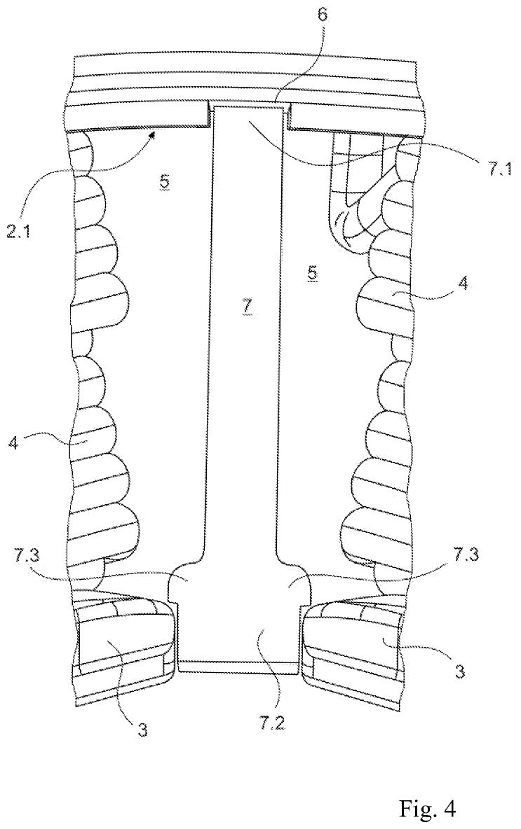

FIG. 4 shows a schematic detail illustration of a planar insulator element 7 in an axial view from above in the interstice 5 between two adjacent coils 4. The foot end 7.1 of the planar insulator element 7 is held in the holding groove 6. The holding groove 6 is formed in the centre between the adjacent coil carriers and extends axially along the stator inner side 2.1 between the axial end sides 1.1 and 1.2. The opposing face sides of the planar insulator element 7 are parallel from the foot end 7.1 as far as the protrusions 7.3. The protrusions 7.3 are formed on both sides of the planar insulator element 7. The undersides of the protrusions 7.3 have a radius transverse to the longitudinal axis. Radially inwards, the protrusions 7.3 form supporting ridges for supporting the flank underside of adjacent inner flanges 3. The head end 7.2 of the planar insulator element 7 is clamped between the opposing flanks of adjacent inner flanges 3 such that the flank faces of the opposing flanks of the adjacent inner flanges 3 bear fully against the planar insulator element 7. These common contact faces extend over the entire long side of the planar insulator element 7. The head end 7.2, which is clamped between the opposing flanks of the adjacent inner flanges 3, is wider than the foot end 7.1, which is held in the holding groove 6. The holding groove 6 contains the electrically insulating substance, which forms an adhesive bond with the foot end 7.1 of the planar insulator element 7 inserted in the holding groove 6. The electrically insulating substance is also situated on the contact regions of the head end 7.2 on the supporting ridges of the protrusions 7.3, which are directed with the supporting ridges against the undersides of the adjacent inner flanges 3 and are positioned between the opposing flanks of adjacent inner flanges 3 and the head end 7.2.

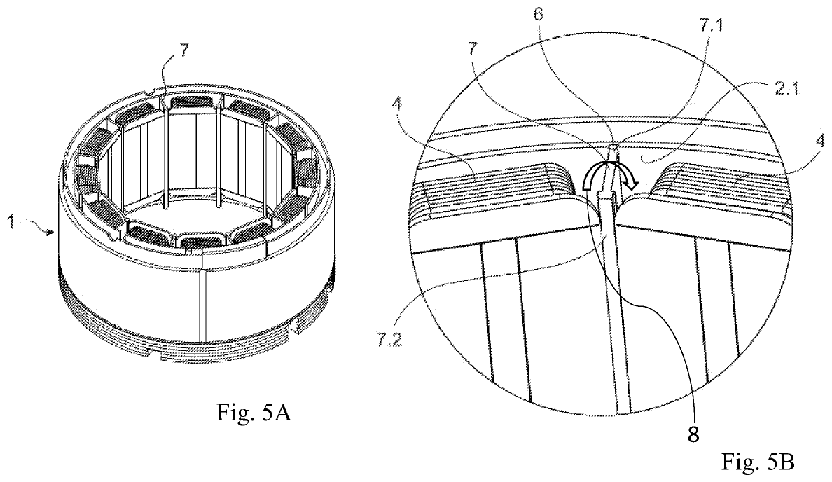

FIGS. 5A to 5B show further schematic illustrations of views of the insulation system according to the invention in a stator 1. FIG. 5A shows a stator 1 with the insulator system according to the invention with planar insulator elements 7 arranged between adjacent coils. FIG. 5B shows an enlarged detail of a region of the stator 1 shown in FIG. 5A. As can be seen, the planar insulator elements 7 protrude beyond the coils 4 in the axial direction, as a result of which they are higher than the upper and lower axial ends of the coils 4. A current flow between the coils 4 is made much more difficult by the lengthened air path, which is indicated with the arrow 8. The arrow 8 indicates the air path lengthened by the planar insulator elements 7 between the coils 4. This does not mean that a current flow takes place between the coils 4. In stator arrangements from the prior art, coil separators do not protrude beyond the coils, and therefore the air path between the coils is shorter, which increases the risk of an undesired current flow between the coils. The essential advantage of the invention in comparison with the prior art is the elimination of paths for electrical current, since the planar insulator elements 7 extend over the entire axial length of the stator 1 and protrude beyond the coils 4.

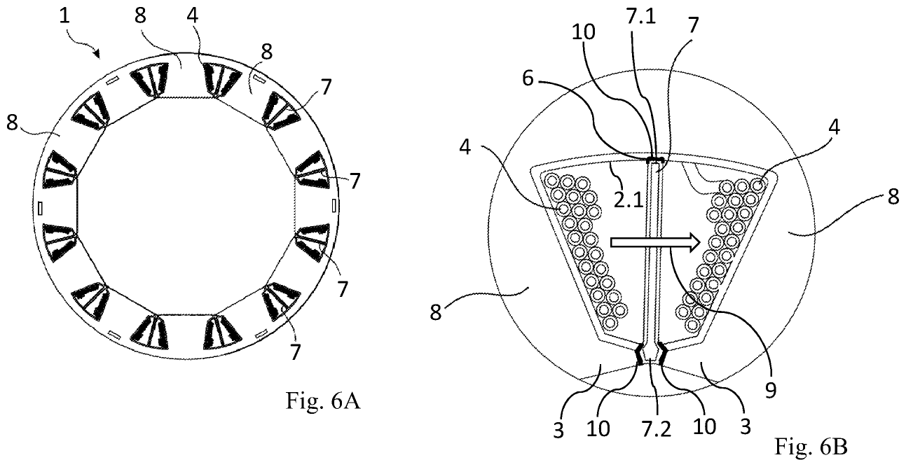

FIGS. 6A and 6B show further schematic illustrations of views of the insulator system according to the invention in a stator 1. FIG. 6A shows a stator 1 with the insulator system according to the invention with planar insulator elements 7 arranged between adjacent coils 4. FIG. 6A is a sectional illustration of the stator, and therefore the coil carriers 8 are visible. FIG. 6B shows an enlarged detail of a region of the stator 1 shown in FIG. 6A. As shown in FIG. 6B, a current flow between the adjacent coils 4 in the direction of the arrow 9 or in the opposite direction is prevented by the arrangement of the planar insulator element 7.

The holding groove 6 formed on the stator inner side 2.1 contains the electrically insulating substance 10, which forms an adhesive bond with the foot end 7.1 of the planar insulator element 7 inserted in the holding groove 6. The position of the electrically insulating substance is indicated with the thick black line. The glued connection means that all the contact faces between the stator 1 and the planar insulator elements 7 are adhesively bonded to one another. The most important thing about this adhesive connection is that no current can flow from one coil 4 to the other through this barrier. Accordingly, air gaps and creepage paths only remain where there are no adhesive connections. The adhesive connection, which can also be referred to as a cemented joint, is situated at the foot end 7.1 and at the head end 7.2 of each planar insulator element 7. At the head end 7.2, the positions of the electrically insulating substance 10 are likewise indicated with thick black lines. At the head end 7.1, the electrically insulating substance 10 is situated in the contact region with an adjacent inner flange 3. Because the electrically insulating substance is positioned over the entire axial length of the planar insulator elements 7 at the foot end 7.1 and at the head end 7.2, the current on the rear of the stator cannot flow directly from one phase of a coil 4 to the other, for example. Since the foot ends 7.1 of the planar insulator elements 7 are adhesively bonded to the stator encapsulation, a current can only flow via the planar insulator elements 7 to be able to reach another phase of a coil 4. However, this is prevented by the lengthened air path, as shown in FIG. 5B with the arrow 8.

### LIST OF REFERENCE NUMERALS

1 Stator
1.1 First end side
1.2 Second end side
2.1 Stator inner side
2.2 Stator outer side
3 Inner flange
4 Coil
5 Interstice, stator groove
6 Holding groove
7 Planar insulator element
7.1 Foot end
7.2 Head end
7.3 Protrusion/protrusions
8 Coil carrier
9 Arrow
10 Position with electrically insulating substance

What is claimed is:

1. An insulation system for a stator of an electric motor of an electrical compressor, wherein the stator has multiple coil carriers which point radially inwards from a stator inner side and have inner flanges spaced apart on a head side, the inner flange radially delimiting coils wound onto the coil carriers with electrical conductors, wherein the insulation system comprises insulator elements which are each held at a foot end by holding grooves formed on the stator inner side in an axial direction between axial end sides of the stator and are positioned pointing radially inwards between adjacent ones of the coils with head ends between opposing flanks of adjacent ones of the inner flanges, wherein an electrically insulating substance is introduced in contact regions between the insulator elements and the holding grooves and/or between the insulator elements and the inner flanges of the coil carriers.

2. The insulation system according to claim 1, wherein the insulator elements have protrusions which are formed on opposing face sides in a head region and form supporting ridges pointing in the axial direction and each having a supporting face for the opposing flanks of the adjacent ones of the inner flanges (3).

3. The insulation system according to claim 2, wherein the insulator elements are dimensioned such that, in an installed state, they are each oriented with the supporting ridges radially inwards against flank undersides of the adjacent ones of the inner flanges.

4. The insulation system according to claim 2, wherein the insulator elements are radially dimensioned larger than a distance between a groove bottom of the holding grooves and flank undersides of the adjacent ones of the inner flanges.

5. The insulation system according to claim 1, wherein a resin or an adhesive is used as the electrically insulating substance.

6. The insulation system according to claim 1, wherein the electrically insulating substance is introduced by vacuum pressure processes.

7. The insulation system according to claim 1, wherein the insulator elements protrude with the head ends pointing radially inwards beyond the inner flanges.

8. The insulation system according to claim 1, wherein the insulator elements protrude in the axial direction beyond the coils of the coil carriers.

9. The insulation system according to claim 1, wherein the insulator elements can be inserted from an axial end side of the stator.

10. The insulation system according to claim 1, wherein the insulator elements are planar.

11. A method for installing the insulation system according to claim 10 in the stator of the electric motor the electrical compressor, wherein the planar insulator elements are each positioned with the foot end in the holding grooves formed on the stator inner side in the axial direction between the axial end sides of the stator, and pointing radially inwards between the adjacent ones of the coils, and are clamped with the head ends between the opposing flanks of the adjacent ones of the inner flanges, wherein the electrically insulating substance is introduced in the contact regions between the planar insulator elements and the holding grooves and/or between the planar insulator elements and the inner flanges of the coil carriers.

12. The method according to claim 11, wherein the electrically insulating substance is introduced by a vacuum pressure process.

13. The method according to claim 12, wherein a curable substance is used as the electrically insulating substance.
